(19) United States
(12) Patent Application Publication
(10) Pub. No.: US 2009/0172389 A1
(43) Pub. Date: Jul. 2, 2009

(54) SECURE CLIENT/SERVER TRANSACTIONS

(75) Inventor: Moshe Maor, Santa Clara, CA (US)

Correspondence Address: INTEL CORPORATION;c/o CPA Global, P.O. BOX 52050, MINNEAPOLIS, MN, 55402, US

(73) Assignee: INTEL CORPORATION, Santa Clara, CA (US)

(21) Appl. No.: 11/967,978

(22) Filed: Dec. 31, 2007

(51) Int. Cl. H04L 9/00

(52) U.S. Cl. 713/150

(57) ABSTRACT

In some embodiments a controller establishes a secured connection between a remote computer and a user input device and/or a user output device of a computer. Information is securely transmitted in both directions between the remote computer and the user input device and/or user output device in a manner such that a user of the user input device and/or the user output device securely interacts with the remote computer in a manner that cannot be maliciously interfered with by software running on the computer. Other embodiments are described and claimed.

### RELATED APPLICATIONS

This application is related to the following applications filed on the same date as this application:

“Personal Guard” to Moshe Maor, Attorney Docket Number P25461.

“Management Engine Secured Input” to Moshe Maor, Attorney Docket Number P25460;

“Personal Vault” to Moshe Maor, Attorney Docket Number P26881;

“Secure Input” to Douglas Gabel and Moshe Maor, Attorney Docket Number P26882.

### TECHNICAL FIELD

The inventions generally relate to secure client/server transactions.

### BACKGROUND

Many different types of keyloggers currently exist to allow hackers to hook into different layers in the software stack of a user's computer. The hooking point can be as low (that is, as close to the hardware) as a keyboard base driver or as high (that is, as far from the hardware) as a script that runs inside the scope of an internet browser. In this manner, software based keyloggers and other types of malware (malicious software) may be used by a hacker to hijack sensitive information that a user types into a computer. Although some software capabilities are currently used to try to mitigate malware, those solutions are all reactive solutions that are provided after a new malware version has been identified. Further, those software solutions never provide a complete solution. They merely close one gap while others are still open and used by newer malware. Therefore, a need has arisen to protect a user's sensitive information from a hacker using keyloggers and other types of malware.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a sequence diagram according to some embodiments of the inventions.

FIG. 5 illustrates a graphic representation according to some embodiments of the inventions.

FIG. 6 illustrates a system according to some embodiments of the inventions.

FIG. 7 illustrates a sequence diagram according to some embodiments of the inventions.

### DETAILED DESCRIPTION

Some embodiments of the inventions relate to secure client/server transactions.

In some embodiments, a controller establishes a secured connection between a remote computer and a user input device and/or a user output device of a computer. Information is securely transmitted in both directions between the remote computer and the user input device and/or user output device in a manner such that a user of the user input device and/or the user output device securely interacts with the remote computer in a manner that cannot be maliciously interfered with by software running on the computer.

In some embodiments, a secured connection is established between a remote computer and a user input device and/or a user output device of a computer. Information is securely transmitted in both directions between the remote computer and the user input device and/or user output device in a manner such that a user of the user input device and/or the user output device securely interacts with the remote computer in a manner that cannot be maliciously interfered with by software running on the computer.

In some embodiments, a method includes establishing a secured connection between a remote computer and a user input device and/or a user output device of a computer, starting a secured transaction between the remote computer and the user input device and/or the user output device, and sending securely user information between the remote computer and the user input device and/or the user output device.

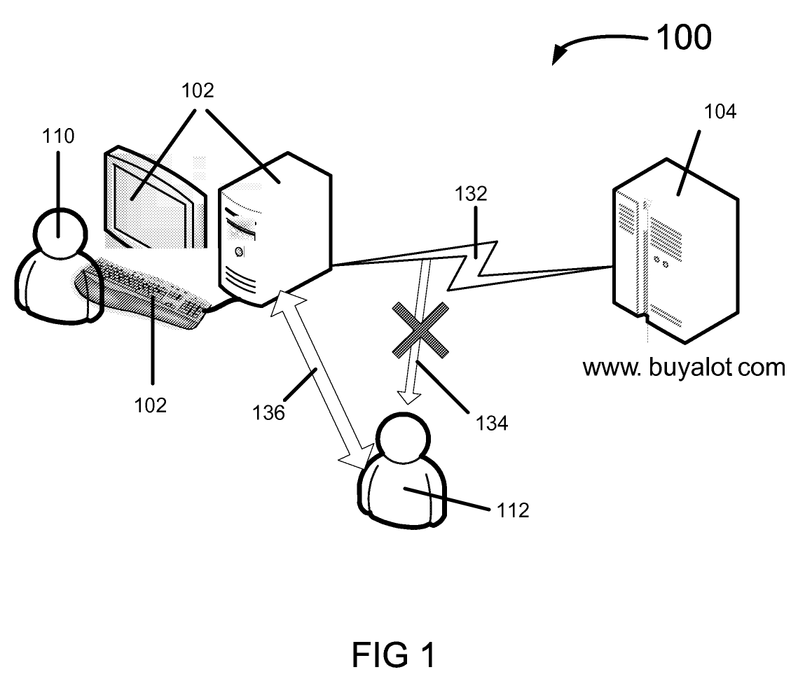

FIG. 1 illustrates a system 100 according to some embodiments. In some embodiments system 100 includes a computer 102 and a remote server 104. FIG. 1 illustrates how an end user 110 (for example, an on-line purchaser of goods and/or services) that is doing some on-line shopping using the computer 102 that is connected to the remote server 104 (for example, via the internet) may be open to attacks from a hacker 112. In the on-line shopping example, a common scenario might include the following numbered steps:
1. The end user 110 is using an internet browser loaded on computer 102 to surf in an e-commerce web site to choose good for purchase (for example, via a remote server 104 of a “www.buyalot.com” web site)
2. The user 110 picks some goods from the “www.buyalot.com” web site and places them into a virtual basket
3. At some point when the user 110 has finished choosing goods for purchase, the user hits a checkout button
4. The e-commerce server 104 opens a form in a window for the user 110 and asks for the user to enter payment information in the form
5. The user 110 types sensitive data into fields of the form such as, for example, a credit card number, phone number, full name, address, etc.
6. The e-commerce server 104 sends back a receipt to the user

During the most sensitive portions of the exemplary scenario discussed above (for example, during steps 4 and 5), the communication between the internet browser of the user 110 and the server 104 of the remote site is typically run on top of a secured connection 132 such as a secure socket layer (SSL) and/or a transfer layer security (TLS), for example. This precludes any adversary such as hacker 112 on the internet that wishes to capture the sensitive data entered by the user from obtaining that data without first breaking cryptographic algorithms used by the secured connected (that is, SSL and/or TLS cryptographic algorithms). This is not typically a problem due to a very high computation complexity that would be required by the hacker 112. Arrow 134 illustrates an attempt by hacker 112 to obtain information via this method. An “X” is included over arrow 134 to illustrate the extreme difficulties in attempting this type of theft attempt.

The typical user 110 is normally aware of the fact that some protection is necessary in order to avoid theft of personal information entered in such a scenario. For example, most users know to look for a special icon normally displayed on a control line of the internet browser that indicates that the current session is being executed over a secured connection. However, a sophisticated hacker 112 may attempt to steal the sensitive information using a completely different approach that is not protected by using a secured connection 132 such as SSL or TLS. For example, in some embodiments, hacker 112 may use a keylogger or other malware to obtain the sensitive information, as illustrated via arrow 136 in FIG. 1. Many different types of keyloggers and/or other malware are currently available, and have the ability to hook into different layers in the software stack running on computer 102, for example. The hooking point for the keyloggers and/or malware can be as low (that is, closer to the hardware) as a keyboard base driver or as high (that is, further from the hardware) as a script that runs inside the scope of the internet browser running on computer 102, for example. Therefore, while it is very important to mitigate network theft attacks on the sensitive data, it is not enough to entirely mitigate theft attacks of sensitive data (resulting, for example, in identity theft).

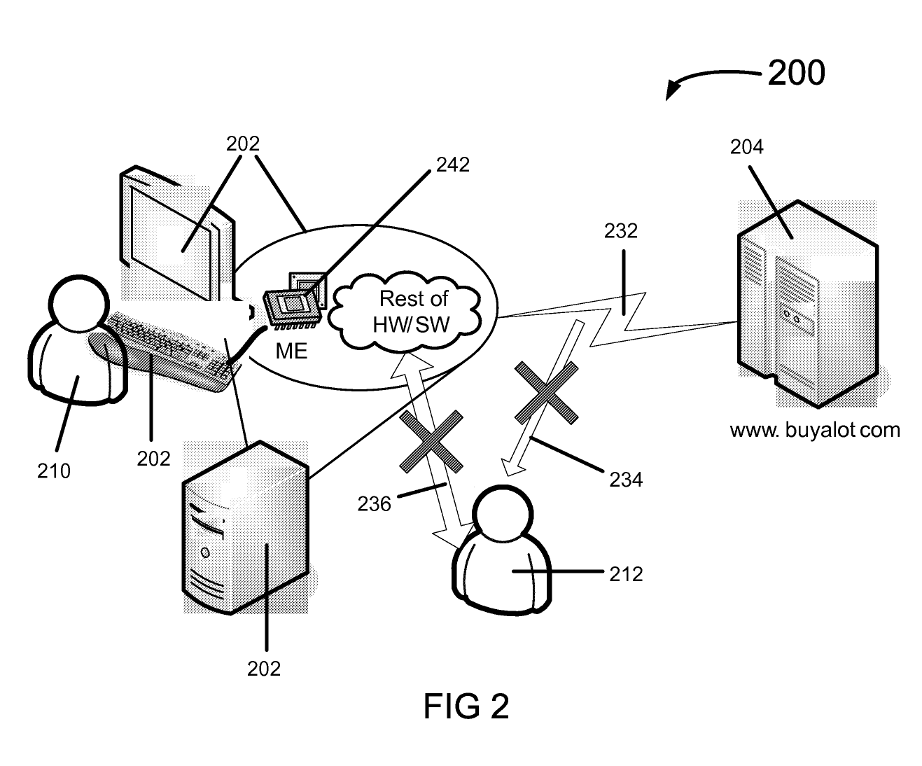

FIG. 2 illustrates a system 200 according to some embodiments. In some embodiments system 200 includes a computer 202 and a remote server 204. FIG. 2 illustrates how an end user 210 (for example, an on-line purchaser of goods and/or services) that is doing some on-line shopping using the computer 202 that is connected to the remote server 204 (for example, via the internet) may guard from attacks from a hacker 212. Similar to the arrangement described in reference to FIG. 1, the communication between the internet browser of the user's computer 202 and the server 204 of the remote site is typically run on top of a secured connection 232 such as a secure socket layer (SSL) and/or a transfer layer security (TLS), for example. This precludes any adversary such as hacker 212 on the internet that wishes to capture the sensitive data entered by the user from obtaining that data without first breaking cryptographic algorithms used by the secured connected (that is, SSL and/or TLS cryptographic algorithms).

Computer 202 includes a management engine (and/or manageability engine and/or ME). In some embodiments, ME 242 is a micro-controller and/or an embedded controller. In some embodiments, ME 242 is included in a chipset of computer 202. In some embodiments, ME 242 is included in a Memory Controller Hub (MCH) of computer 202. In some embodiments, ME 242 is included in a Graphics and Memory Controller Hub of computer 202.

In some embodiments, ME 242 may be implemented using an embedded controller that is a silicon-resident management mechanism for remote discovery, healing, and protection of computer systems. In some embodiments, this controller is used to provide the basis for software solutions to address key manageability issues, improving the efficiency of remote management and asset inventory functionality in third-party management software, safeguarding functionality of critical agents from operating system (OS) failure, power loss, and intentional or inadvertent client removal, for example. In some embodiments, infrastructure supports the creation of setup and configuration interfaces for management applications, as well as network, security, and storage administration. The platform provides encryption support by means of Transport Layer Security (TLS), as well as robust authentication support.

In some embodiments the ME is hardware architecture resident in firmware. A micro-controller within a chipset graphics and memory controller hubs houses Management Engine (ME) firmware, which implements various services on behalf of management applications. Locally, the ME can monitor activity such as the heartbeat of a local management agent and automatically take remediation action. Remotely, the external systems can communicate with the ME hardware to perform diagnosis and recovery actions such as installing, loading or restarting agents, diagnostic programs, drivers, and even operating systems.

Personal guard technology included in system 200 can be used to completely mitigate any attempted attacks from keyloggers and other types of malware. In some embodiments, management engine (and/or manageability engine and/or ME) 242 included within computer 202 takes control over the keyboard of the computer 202 and sets up a trusted path between the user 210 and the ME 242 via any input devices of computer 202 such as the keyboard. Additionally, the ME 242 sets up a secured path (although not a direct connection) between the ME 242 and the remote server 204.

When funneling the sensitive data via the ME 242, the ME 242 actually encrypts the sensitive data that the user 210 types, for example, before the software running on computer 202 obtains the data (for example, sensitive data such as credit card numbers, phone numbers, full name, addresses, etc.) In this manner, when the software that runs on the host processor, for example, of computer 202 is handling the data it is already encrypted and is therefore not usable for keyloggers in an attempt to steal the data via arrow 236 by the hacker 212. Therefore, no matter what type of keylogger is able to infiltrate computer 202 and is currently running on the host processor of computer 202 as part of the software stack, the sensitive data of the user 210 is kept secret when personal guard operations (for example, via ME 242) are being used while user 210 is typing the data.

FIG. 2 has described using personal guard operations to mitigate hacker attempts such as keyloggers from stealing sensitive data entered by a user. However, it is recognized that a management engine such as ME 242 of FIG. 2 is not necessary for all embodiments, and that other devices may be used to implement the same types of operations as described herein. Additionally, an Intel branded ME and/or Intel AMT is not necessary for all embodiments, and other devices may be used to implement the same types of operations as described herein.

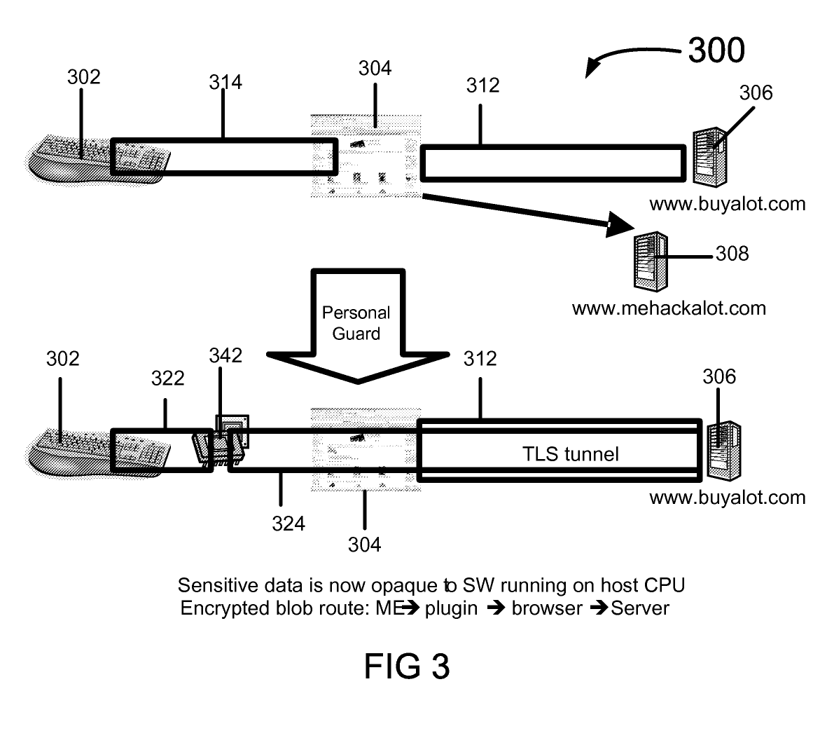

FIG. 3 illustrates a system 300 according to some embodiments. In some embodiments system 300 includes an input device 302 (for example, a keyboard, a mouse, and/or any other type of input device), an Operating System (OS) and/or internet browser 304, a remote server 306, and a hacker (and/or a hacker computer) 308. FIG. 3 illustrates a difference between a system that is guarded by internet based encryption such as SSL or TLS in the top portion of FIG. 3 and a system that is guarded with personal guard technology in a bottom portion of FIG. 3. In the top portion of FIG. 3 a secured connection 312 (for example, using SSL and/or TLS and/or tunneling technology) occurs between the OS/internet browser 304 and the remote server 306, and software based input/output 314 occurs between input device 302 and the OS/internet browser 304. In the scenario illustrated at the top of FIG. 3, the hacker 308 can use malware and/or keyloggers to intercept and make use of sensitive data input by a user. In the bottom of FIG. 3, on the other hand, a secured connection 322 is provided between a portion 342 of a user computer (for example, such as a Management Engine or ME) and the OS/internet browser 304 using personal guard technology according to some embodiments, for example. Additionally, sensitive data is encrypted at 324 between the portion 342 (such as an ME) and the remote server 306 using personal guard technology according to some embodiments, for example. In this manner, software based keyloggers and other types of malware may not be used to hijack sensitive information input by a user at input device 302.

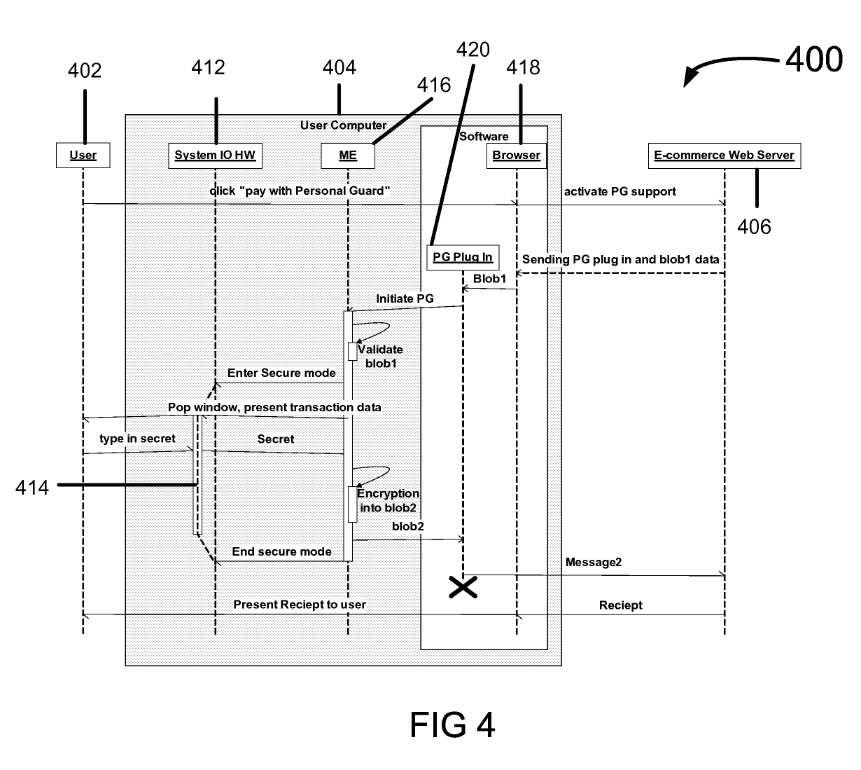

FIG. 4 illustrates a sequence diagram 400 according to some embodiments. Sequence diagram 400 includes a user 402, a computer 404 of the user 402, and a server (for example, an e-commerce web server) 406. Computer 404 includes system input/output hardware (system I/O HW) 412, an input device (for example, a keyboard and/or a mouse) 414, a management engine (and/or manageability engine and/or ME) 416, a browser 418, and a plug in 420. The system I/O HW 412, the input device 414, and the ME 416 are all implemented, for example, in hardware and/or firmware and the browser 418 and the plug in 420 are all implemented, for example, in software. User 402 is a person who is using computer 404 to browse a remote site for which secured input is desired. The user 402 wishes to secure the input using personal guard technology in order to send sensitive information (for example, as part of a transaction) to the remote server 406. System I/O HW 412 is core I/O control implementation within the computer 404 being used by user 402. It is implemented, for example, in the chipset of the computer 404, and includes modules that support secured input and secured output. The input device 414 is an external hardware device through which the user 402 enters sensitive data (for example, by typing in the sensitive data on a keyboard). The ME 416 is also included, for example, in the chipset of the computer 404 of the user 402 and controls the secured I/O flows of the system I/O HW and implements (for example, in firmware) the main personal guard flow. The browser 418 is the software that the user 402 normally executes on the computer 404 to browse web sites on the internet It is noted that personal guard technology according to some embodiments may be used to harden the secured login, for example, of other internet technologies, so a web browser is just an example and is not required in some embodiments. Plug in 420 is a browser plug in used to convey data between the ME 416 (and/or personal guard firmware application) and the remote server 406. The remote server 406 (for example, an e-commerce web server) is a server with which the user 402 is executing some transactions. The server 406 is aware of the personal guard technology being used by the ME 416 and is therefore able to take advantage of secured transactions.

In some embodiments the user 402 clicks a selection such as “pay with Personal Guard” and the browser software 418 then activates Personal Guard support with the server 406. Server 406 then sends a Personal Guard plug in and data (for example, “blob 1”) to the Personal Guard plug in 420 via the browser 418. Plug in 420 then sends an “initiate Personal Guard” signal to the ME 416, which then validates the data (“blob 1”), and causes the user computer 404 to enter a secure mode, causing a pop up window to be displayed to the user 402 in which the user can securely enter sensitive and/or secret data. User 402 enters this data via input device 414 secretly and securely, and the ME 416 encrypts the data (for example, into “blob2”). The encrypted data is then sent via the browser 418 and/or plug in 420 software to the server 406 (for example, as “message2”). The server 406 sends a receipt back to the computer 404, which is presented to the user 402. In this manner any sensitive and/or secret data input by the user 402 to the server 406 via computer 404 is securely transmitted, and software based keyloggers and/or any other types of malware are not able to hijack any of the input data.

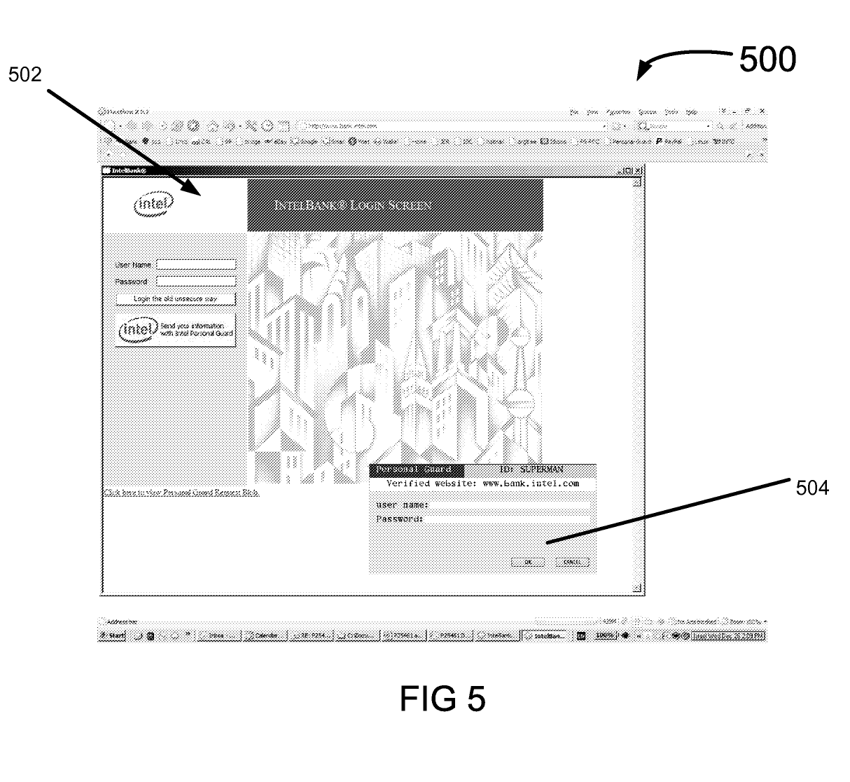

FIG. 5 illustrates a graphic representation 500 according to some embodiments. Graphic representation 500 includes a web site 502 of a vendor (for example, such as a bank or a web site shopping site, etc.) A special Personal Guard login may be used in addition to or instead of the typical web site login. A personal guard window 504 is output on the screen over or beside the web site display, for example, by an ME as secured graphics output through which a user communicates with the ME to convey sensitive information (such as credit card numbers, login credentials, a password to login to a web site, phone number, full name of user, address, social security numbers, etc.)

A personal guard plug-in triggers the ME to show the personal guard window 504. Window 504 cannot be captured by software running on the CPU, for example. When data is encrypted by the ME, it is sent to the server of the web site (for example, a bank web site as shown in FIG. 5). The server of the web site is the only one who can decrypt the data and obtain the ID and/or passcode data, for example. The window 504 includes, for example, a special ID that ensures a user that the ME drew that window (for example, “ID: superman”), an animation (for example, “A” at top left of window 504) that runs when user input goes into the ME, an explicit URL of the remote server to help mitigate address-bar spoofing, which is the number one phishing technique of hackers (for example, in FIG. 5 “www.bank.intel.com”), user credentials such as ID, passcode, etc. stored in secured storage of the ME so that a user does not need to type the data every time (after the initial ME login). The secured input allows the user to enter and manipulate the data, and user data may be clearly shown in window 504 or fully or partially blocked by using, for example, “********”, but in any case whether the data is shown or not shown in window 504 it cannot be read by any software application running on the user's computer or by a hacker trying to use keylogger software and/or other malware.

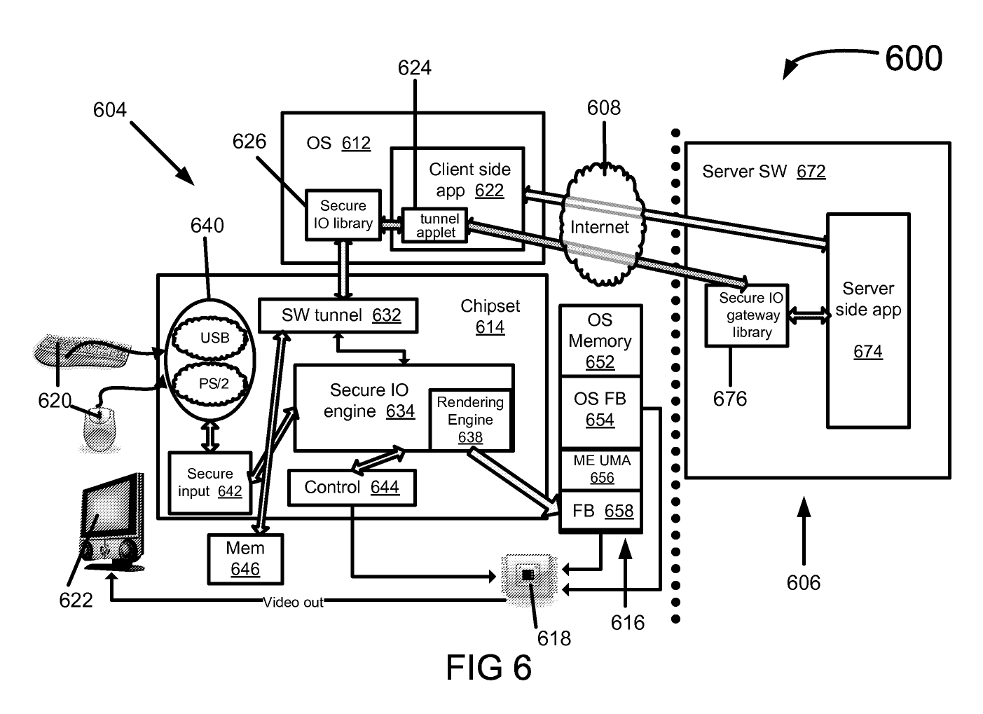

FIG. 6 illustrates a system 600 according to some embodiments. System 600 includes a client side 604 and a server side 606 that is coupled together via a connection such as the internet 608. Client side 604 includes an Operating System (OS) 612, a chipset 614, memory 616, a graphics/display engine 618, input device(s) 620 (for example, a keyboard and/or a mouse), and output device(s) 622 (for example, a display). OS 612 includes a client side application 622 that includes a tunnel applet 624, and OS 612 also includes a Local Manageability Service (LMS) 626 that acts as a proxy for the chipset 614 for management applications.

Chipset 614 includes a software tunnel 632 and a controller 634 (for example, a Management Engine, a Manageability Engine, an ME, and/or a secure IO engine) that includes a rendering engine 636. Chipset 614 also includes an input interface 640 (for example, a USB and/or PS/2 interface) to interface to the input device(s) 620. Chipset 614 also includes a secure input controller 642 and an output controller (for example, a display controller) 644. Chipset 614 stores identity information in a non-volatile memory 646. Memory 616 includes OS memory 652 and an OS frame buffer 654. Memory 616 further includes extended memory 656 for code for controller 634 and to store run-time data for controller 634 (for example, ME external memory or ME UMA) as well as a frame buffer 658. Server side 606 includes server software 672. Server software 672 includes a server side application 674 and a secure IO gateway library 676.

In some embodiments, a secure client/server (and in some cases a secure client/client) transaction is possible where the transaction cannot be modified by any local software running on the client. The transaction is based on direct input/output (IO or I/O) between the user and a controller (for example, controller 634 and/or an embedded controller) that runs, for example, closed firmware. In some embodiments, the controller is an ME included in a chipset.

In some embodiments, a generic infrastructure is possible that can be used to establish secured IO connection between a user and a remote application (for example, in some embodiments the remote application is a web application, a login facility, and/or an enterprise server, etc.) The secure connection allows the user to securely interact with the remote server application in a way that cannot be spoofed by any malware running on a local system. In some embodiments, this is accomplished by setting a Transfer Layer Security (TLS) connection, a Secure Socket Layer (SSL) connection and/or some other type of connection and/or tunnel between the controller (for example, ME) and a remote computer (for example, a remote server as illustrated in FIG. 6). During the connection or tunnel session, packets are sent back and forth to display information on a user monitor and to receive user input from a user input device. A remote computer such as a server can also receive a positive indication that the user is physically at the user's computer, for example, since using secure IO at the platform level mitigates software applications that are “emulating” user input. In some embodiments, this can be used for some very important and various usages. In some embodiments, interactions between a local computer and a remote computer (for example, a remote server) can be encrypted and signed. For example, in some embodiments, a request for a user password or other private information and/or the provision of that information is signed and encrypted.

In some embodiments, the controller 634 (for example, an embedded controller and/or ME) is included in the local computer platform and is running signed and protected firmware. In some embodiments, secure output capability to the output device (for example, output device 622) is used, for example, so that the controller 634 uses a “sprite” on the user's monitor in a way that is protected from software that is running on the host CPU (for example, client applications and/or OS). In some embodiments, secure input if provided from the input device 620 (for example, keyboard and/or mouse) in a manner such that the controller 634 has a direct connection to the input device (that is, not via a software stack that is running on the host CPU). For example, such a secure input implementation is described in further detail in a U.S. patent application filed on even date herewith entitled “Secure Input” to Douglas Gabel and Moshe Maor, Attorney Docket Number P26882.

In some embodiments, local software (for example, client side application or applications 622) is used as a conduit between a controller (for example, controller 634) and a remote server application (for example, server side application or applications 674). In some embodiments, a server application running remotely on a protected server (for example, server side application or applications 674) may be used to terminate the communication.

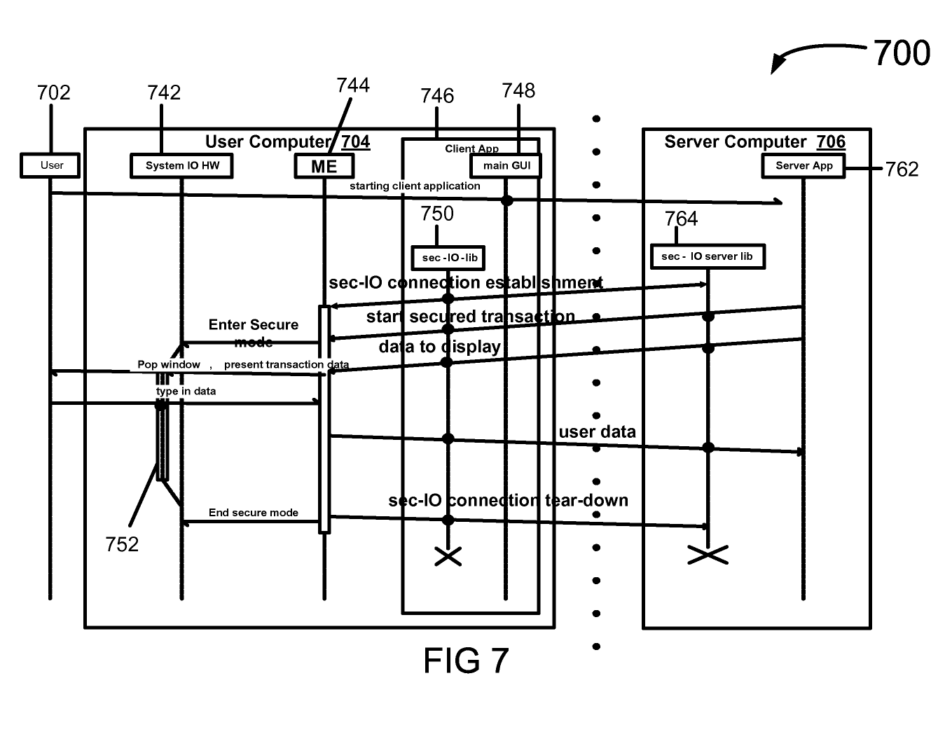

FIG. 7 illustrates a sequence diagram 700 according to some embodiments. FIG. 7 illustrates a user 702, a user computer 704, and a server computer 706. User computer 704 includes system Input/Output (I/O) hardware 742, a controller 744 (for example, a management engine, manageability engine, and/or ME), client application 746 including a main Graphical User Interface (GUI) 748 and a secure I/O library 750, and an input and/or output device 752 (for example, a keyboard and/or a display). Server computer 706 includes a server application 762 and a secure I/O server library 764.

In some embodiments, user 702 initiates a client application via the main GUI 748 and an indication is transmitted to the server computer 706. The client application 746 is then used to establish a secure I/O connection between the secure I/O library 750, the secure I/O server library 764, and/or the controller 744. The server application 762 then starts a secured transaction via the secure I/O server library 764, the secure I/O library 750 and the controller 744, and the controller 744 enters the system I/O hardware 742 of the user computer 704 into a secure mode. Display data is transmitted from the server application 762 to the controller 744, and a pop-up window presents data to the user (for example, transaction data). The user 702 types in data and/or a request for data on the input and/or output device 752 that is sent to the controller. The controller 744 then sends user data (either the data that the user has typed in and/or data that has been securely stored and controlled by the controller 744) back to the server application 762. At some point the user no longer wishes and/or needs to have a secure interaction with the server so the secure I/O connection is then torn down. A message is sent to the secure I/O server library and the controller 744 ends the secure mode that was previously entered.

In some embodiments, according to a flow for starting a client/server application, the secure IO session is started between secure IO libraries in the client and in the server. The secure IO session may be used to send secure data from the remote server to the user in a secure manner. In some embodiments, a standard security level is used which relies on a regular TLS and/or SSL connection in a manner that is currently used in client/server applications to provide protection against eavesdroppers along the way. In some embodiments, a hardened security level is used where an SSL and/or TLS tunnel ends inside a secure controller (for example, controller 634 and/or controller 744) and provides direct and secure IO between a remote computer such as a remote server and the controller such that the connection cannot be spoofed by local malware. In some embodiments, both the standard security level and the hardened security level are used.

In some embodiments, a controller 744 identity data that can be used to attest the controller 744 to the remote server 706 may be used to achieve trust. That is, the remote computer 706 knows that it is securely interacting with a secure controller such as controller 744 and not interacting with the software that is emulating that controller. Further, in some embodiments, a controller such as controller 744 can verify a remote server certificate, and according to specific application policy, will decide whether to open the secure connection with the server. The controller can also determine what policies are bounded to the secure tunnel connection.

In some embodiments, a secured two-way communication tunnel is provided where server data and user data are both secured. In some embodiments, a secured “thin server” solution is possible where many usages can be defined. In some embodiments, any usage may be made where a server and/or a client application requires proof of physical user presence at a local machine. In some embodiments, usages include active directory secure login, bank account control, financial client to business (C2B) web applications, and/or working with government related services, etc.

While some embodiments have been described herein as being between a client and a server, it is recognized that there are other embodiments. For example, in some embodiments, secure IO between two clients (for example, a local client and a remote client) is possible.

Although some embodiments have been described herein as being implemented in a particular manner, according to some embodiments these particular implementations may not be required. For example, although some embodiments have been described as using an ME, other embodiments do not require use of an ME.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a controller to establish a secured connection between a remote computer and a user input device and/or a user output device of a computer, and to securely transmit information in both directions between the remote computer and the user input device and/or user output device in a manner such that a user of the user input device and/or the user output device securely interacts with the remote computer in a manner that cannot be maliciously interfered with by software running on the computer.

2. The apparatus of claim 1, wherein the secured connection includes a standard connection that provides protection against eavesdroppers and also includes a hardened security level between the remote computer and the controller.

3. The apparatus of claim 1, further comprising a secure library to help the controller to establish the secured connection.

4. The apparatus of claim 3, wherein the secure library is included in the computer.

5. The apparatus of claim 3, wherein the secure library is included in the remote computer.

6. The apparatus of claim 1, further comprising a tunnel applet to help the controller to establish the secured connection.

7. The apparatus of claim 1, further comprising protected firmware running on the controller to establish the secured connection.

8. The apparatus of claim 1, further comprising local software running on the computer to help the controller to establish the secured connection.

9. The apparatus of claim 1, wherein the secured connection provides a secure connection between the user input device and/or the user output device with a remote application running on the remote computer.

10. The apparatus of claim 1, the controller to provide identity information to the remote computer to achieve trust.

11. A method comprising:
establishing a secured connection between a remote computer and a user input device and/or a user output device of a computer; and
securely transmitting information in both directions between the remote computer and the user input device and/or user output device in a manner such that a user of the user input device and/or the user output device securely interacts with the remote computer in a manner that cannot be maliciously interfered with by software running on the computer.

12. The method of claim 11, wherein the secured connection includes a standard connection that provides protection against eavesdroppers and also includes a hardened security level between the remote computer and the controller.

13. The method of claim 11, further comprising providing a secure connection between the user input device and/or the user output device with a remote application running on the remote computer.

14. The method of claim 11, further comprising achieving trust from the remote computer by providing identity information.

15. A method comprising:
establishing a secured connection between a remote computer and a user input device and/or a user output device of a computer;
starting a secured transaction between the remote computer and the user input device and/or the user output device; and
sending securely user information between the remote computer and the user input device and/or the user output device.

16. The method of claim 15, wherein user information is sent securely in both directions.

17. The method of claim 15, further comprising entering a secure mode at the computer when starting the secured transaction.

18. The method of claim 15, further comprising verifying trust between the computer and the remote computer.

19. An article comprising:
a computer readable medium having instructions thereon which when executed cause a computer to:
establish a secured connection between a remote computer and a user input device and/or a user output device of a computer; and
securely transmit information in both directions between the remote computer and the user input device and/or user output device in a manner such that a user of the user input device and/or the user output device securely interacts with the remote computer in a manner that cannot be maliciously interfered with by software running on the computer.

20. The article of claim 20, wherein the secured connection includes a standard connection that provides protection against eavesdroppers and also includes a hardened security level between the remote computer and the controller.

21. The article of claim 20, the computer readable medium further having instructions thereon which when executed cause a computer to:
provide a secure connection between the user input device and/or the user output device and a remote application running on the remote computer.

22. The article of claim 20, the computer readable medium further having instructions thereon which when executed cause a computer to achieve trust from the remote computer by providing identity information.

23. A system comprising:
a computer having an input device and/or an output device; and
a remote computer;
wherein the computer includes a controller to establish a secured connection between the remote computer and the user input device and/or the user output device, and to securely transmit information in both directions between the remote computer and the user input device and/or user output device in a manner such that a user of the user input device and/or the user output device securely interacts with the remote computer in a manner that cannot be maliciously interfered with

24. The system of claim 23, wherein the secured connection includes a standard connection that provides protection against eavesdroppers and also includes a hardened security level between the remote computer and the controller.

25. The system of claim 23, the computer further including a secure library to help the controller to establish the secured connection.

26. The system of claim 23, the remote computer further including a secure library to help the controller to establish the secured connection.

27. The system of claim 23, wherein the secured connection provides a secure connection between the user input device and/or the user output device with a remote application running on the remote computer.

28. The system of claim 23, the controller to provide identity information to the remote computer to achieve trust.
